(19) United States
(12) Patent Application Publication
(10) Pub. No.: US 2018/0088345 A1
(43) Pub. Date: Mar. 29, 2018

(54) LIQUID LENS ARRAY BASED ON ELECTROWETTING METHOD AND METHOD OF MANUFACTURING THE SAME, AND DISPLAY DEVICE USING THE SAME

(71) Applicant: KOREA ADVANCED INSTITUTE OF SCIENCE AND TECHNOLOGY, Daejeon (KR)

(72) Inventors: Yong Hyub WON, Daejeon (KR); Junoh KIM, Daejeon (KR); Cheol Joong KIM, Daejeon (KR); Doo-Seub SHIN, Daejeon (KR); Jun Sik LEE, Daejeon (KR)

(21) Appl. No.: 15/379,594

(22) Filed: Dec. 15, 2016

(30) Foreign Application Priority Data
Sep. 23, 2016 (KR) 10-2016-0122203

(51) Int. Cl. G02B 27/22; G02B 3/12; G02B 3/00; G02B 26/00; B29D 11/00

(52) U.S. Cl. CPC G02B 27/2214; G02B 3/12; B29K 2033/12; G02B 26/005; B29D 11/00298; G02B 3/0031

(57) ABSTRACT

Disclosed are a liquid lens array based on an electrowetting method, a method of manufacturing the same, and a display device using the same.

The display device includes a display panel configured to display an image. A liquid lens array of the display device is disposed at a side of the display panel, on which an image is displayed, and is capable of controlling an optical axis of a lens, which is formed by a shape between a first liquid and a second liquid, which is not mixed with the first liquid, filled therein be inclined to left and right sides by using an electrowetting phenomenon. A controller controls the optical axis of the lens formed by the shape between the first liquid and the second liquid to be inclined to left and right sides by applying a voltage to the liquid lens array. The optical axis of the lens of the liquid lens array is controlled to be inclined to the left and right sides by the controller, so that it is possible to maintain resolution and increase the number of viewpoints, thereby implementing a high quality 3D image.

### CROSS-REFERENCE TO RELATED APPLICATION

This application claims priority to and the benefit of Korean Patent Application No. 10-2016-0122203 filed in the Korean Intellectual Property Office on Sep. 23, 2016, the entire contents of which are incorporated herein by reference.

### BACKGROUND OF THE INVENTION

### (a) Field of the Invention

The present invention relates to a liquid lens array based on an electrowetting method, a method of manufacturing the same, and a display device using the same.

### (b) Description of the Related Art

Autostereoscopic 3D image technology has a form, in which a function of the stereoscopic glasses is mounted in a display, and a multi-view method is one of the methods for creating a 3D image. The multi-view method is divided into a parallax barrier method and a lenticular method again.

In the case of the parallax barrier method, when a 3D image is reproduced, a barrier blocks most of the light, so that general brightness is considerably decreased, but in the case of the lenticular method, a 3D image may be reproduced without the disadvantage. A lot of various products using the lenticular method have been already sold on the market.

In the meantime, the most important factor among the requirements for creating a high quality 3D image is resolution of a 3D image. In the case of the lenticular method, in order to make the 3D resolution have a maximum value, it is ideal that resolution of a 2D pixel attached on a rear side of a lenticular sheet is followed as it is, but the number of viewpoints is one, so that it cannot be said that an image is 3D. In the lenticular method, it is necessary to convert resolution to a viewpoint for a 3D image, and to this end, it is necessary to make several pixels be included within one lenticular lens and to enable a user to view an image at various angles, and as described above, when the number of included pixels is increased, a multi-view, at which a user may view the image at various angles, is formed. On the other hand, the resolution is decreased as much as the multi-view, so that it is difficult to form a high quality 3D image.

In order to solve the chronic problem, a method of attaching several beam projectors to a rear surface of a display panel and the like are used, but the method has a problem in that a volume of the display panel is increased and power consumption is increased.

Accordingly, a technology of solving an inverse proportional relationship between resolution and the number of viewpoints, which is a problem of a 3D display device based on a general multi-view method, and implementing a high quality 3D image by improving resolution while maintaining the number of viewpoints or increasing the number of viewpoints while maintaining resolution is required.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a liquid lens array based on an electrowetting method, which is capable of implementing a high quality 3D image by maintaining resolution and improving the number of viewpoints, and a method of manufacturing the same, and a display device using the same.

An exemplary embodiment of the present invention provides a liquid lens array, including: a first substrate including a plurality of chambers, and a first electrode and a second electrode, which are not connected with each other, and are formed on both side surfaces of each of the plurality of chambers; and a second substrate configured to seat an upper portion of the first substrate including the plurality of chambers, and including a third electrode formed at a side facing the first substrate, in which a first liquid is filled in a lower portion of the chamber, and a second liquid, which is not mixed with the first liquid, is filled in an upper portion of the first liquid in the chamber.

An insulating layer may be formed in an upper portion of each of the first electrode and the second electrode, and a hydrophobic layer may be formed on the insulating layer.

The first liquid may be oil that is a hydrophobic liquid, and the second liquid may be water that is an electrolyte liquid.

When a first voltage applied between the first electrode and the third electrode is the same as a second voltage applied between the second electrode and the third electrode, a shape of an interface between the first liquid and the second liquid may be a convex lens shape, in which an optical axis is positioned at a center of the lens.

When a first voltage applied between the first electrode and the third electrode is different from a second voltage applied between the second electrode and the third electrode, a shape of an interface between the first liquid and the second liquid may be a convex lens shape, in which an optical axis is inclined to a left side or a right side from a center.

When the first voltage is larger than the second voltage, a shape of an interface between the first liquid and the second liquid may be a convex lens shape, in which an optical axis is inclined to the first electrode side, and when the second voltage is larger than the first voltage, a shape of an interface between the first liquid and the second liquid may be a convex lens shape, in which an optical axis is inclined to the second electrode side.

Another exemplary embodiment of the present invention provides a method of manufacturing a liquid lens array, the method including: forming a plurality of chambers on a first substrate by compressing the first substrate with a mold, in which a plurality of chamber shapes is formed; patterning the chambers on the first substrate by using a negative photoresist; forming a first electrode and a second electrode on both side surfaces of the patterned first substrate, respectively; injecting a first liquid to a lower portion of the plurality of chambers, and injecting a second liquid, which is not mixed with the first liquid, to an upper portion of the first liquid; and sealing the upper portion of the first substrate including the plurality of chambers with a second substrate.

The injecting of the first liquid to the lower portion of the plurality of chambers, and the injecting of the second liquid, which is not mixed with the first liquid, to the upper portion of the first liquid may include: putting the first substrate into a water tank filled with the second liquid, and filling the plurality of chambers on the first substrate with the second liquid; dosing the first liquid within the plurality of chambers by using a micro syringe and positioning the first liquid in a lower portion of the second liquid within the chamber; and sealing the upper portion of the first substrate with the second substrate within the water tank.

The first liquid may be oil that is a hydrophobic liquid, and the second liquid may be water that is an electrolyte liquid.

Still another exemplary embodiment of the present invention provides a display device, including: a display panel configured to display an image; a liquid lens array, which is disposed at a side of the display panel, in which an image is displayed, which includes a first substrate including a plurality of chambers, and a first electrode and a second electrode formed at both side surfaces of each of the plurality of chambers, respectively, and not connected with each other, and a second substrate sealing an upper portion of the first substrate including the plurality of chambers and including a third electrode formed at a side facing the first substrate, in which a first liquid is filled in a lower portion of the chamber and a second liquid, which is not mixed with the first liquid, is filled in an upper portion of the first liquid in the chamber; and a controller configured to control an optical axis of a lens formed by a shape between the first liquid and the second liquid to be inclined to left and right sides by applying a voltage to the liquid lens array.

The controller may control a voltage applied to the liquid lens array so as to have a lens shape suitable to an image displayed on the display panel through communication between the liquid lens array and the display panel.

The controller may control an optical axis of a lens formed by a shape between the first liquid and the second liquid to be positioned at a center of the lens by applying a voltage so that a first voltage applied between the first electrode and the third electrode is the same as a second voltage applied between the second electrode and the third electrode.

The controller may control an optical axis of a lens formed by an interface between the first liquid and the second liquid to be inclined to a left side or a right side from a center of the lens by applying a voltage so that a first voltage applied between the first electrode and the third electrode is different from a second voltage applied between the second electrode and the third electrode. According to the present invention, it is possible to simultaneously form a viewpoint group in a space by time-division driving the liquid lens array based on the electrowetting method.

Accordingly, it is possible to secure two or more times viewpoints without loss of resolution in a display device, so that it is possible to transmit more various and natural viewpoint information to an observer and implement a 3D image having a higher quality compared to that of a general multi-view method.

### BRIEF DESCRIPTION OF THE DRAWINGS

FIG. 1 is a diagram illustrating a schematic configuration of a liquid lens array according to an exemplary embodiment of the present invention.

FIG. 2 is a diagram schematically illustrating a process of compressing a lower substrate in the liquid lens array according to the exemplary embodiment of the present invention.

FIG. 3 is a diagram illustrating a state, in which two electrodes are formed in a chamber of the lower substrate in the liquid lens array according to the exemplary embodiment of the present invention.

FIG. 4 is a diagram illustrating a state, in which a hydrophobic liquid is filled in the chamber of the lower substrate in the liquid lens array according to the exemplary embodiment of the present invention.

FIG. 5 is a lateral cross-sectional view of a basic unit liquid lens corresponding to one chamber in the liquid lens array according to the exemplary embodiment of the present invention.

FIG. 6 is a diagram illustrating a state, in which an optical axis is inclined to a right side after a voltage is applied to the two electrodes of the liquid lens array according to the exemplary embodiment of the present invention.

FIG. 7 is a diagram illustrating a state, in which an optical axis is inclined to a left side after a voltage is applied to the two electrodes of the liquid lens array according to the exemplary embodiment of the present invention.

FIG. 8 is a schematic configuration diagram of a display device according to an exemplary embodiment of the present invention.

FIG. 9 is a schematic perspective view of the display device illustrated in FIG. 8.

### DETAILED DESCRIPTION OF THE EMBODIMENTS

In the following detailed description, only certain example embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, unless explicitly described to the contrary, the word “comprise” and variations such as “comprises” or “comprising”, will be understood to imply the inclusion of stated elements but not the exclusion of any other elements. In addition, the terms “-er”, “-or” and “module” described in the specification mean units for processing at least one function and operation and can be implemented by hardware components or software components and combinations thereof.

Hereinafter, a liquid lens array based on an electrowetting method according to an exemplary embodiment of the present invention will be described with reference to the drawings.

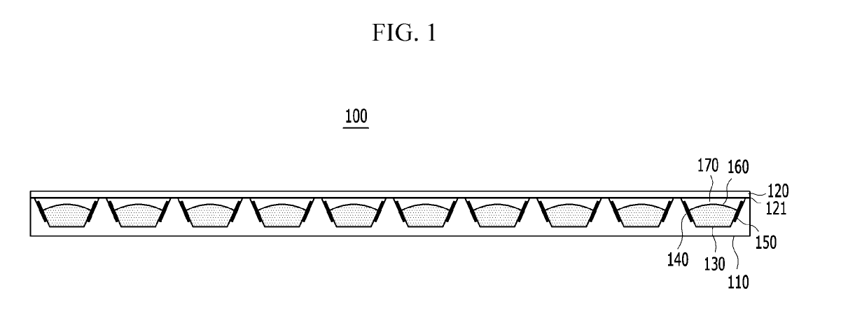

FIG. 1 is a diagram illustrating a schematic configuration of a liquid lens array 100 according to an exemplary embodiment of the present invention.

As illustrated in FIG. 1, the liquid lens array 100 according to the exemplary embodiment of the present invention includes a lower substrate 110, which is a first substrate and is formed of a transparent material, and an upper substrate 120, which is a second substrate bonded to the lower substrate 110 in a form of sealing an upper portion of the lower substrate 110 and is formed of a transparent glass material. Here, the lower substrate 110 is a substrate based on a polymer, such as PMMA, or based on acryl.

A plurality of chambers 130 is formed on the lower substrate 110, and a first electrode 140 and a second electrode 150 are formed on both wall surfaces of each of the plurality of chambers 130, respectively, and although not illustrated, an insulating layer and a hydrophobic layer are sequentially formed on both wall surfaces of each of the plurality of chambers 130 so as to cover the electrodes 140 and 150. The insulating layer and the hydrophobic layer correspond to a general form forming a liquid lens based on the electrowetting method, so that, in the present exemplary embodiment, a particular description thereof will be omitted.

In the meantime, a hydrophobic liquid 140 that is a first liquid, for example, oil, is filled in a lower portion of each chamber 130 of the lower substrate 110, and an electrolyte liquid 170 that is a second liquid, for example, water, is filled in an upper portion of each chamber 130, that is an upper portion of the hydrophobic liquid 160.

The upper substrate 120 is formed in a form of being bonded to the lower substrate 110 so as to seal the upper portions of all of the chambers 130, that is, an upper portion of the lower substrate 110, in order to prevent the hydrophobic liquid 160 and the electrolyte liquid 170 filled in the plurality of chambers 130 from being discharged to the outside of the chambers 130.

Further, an electrode 121 is formed in the lower portion of the upper substrate 120, that is, a part of the upper substrate 120, which is in contact with the electrolyte liquid 170.

In the meantime, the first electrode 140, the second electrode 150, and the electrode 121 may be transparent electrodes or opaque electrodes.

Hereinafter, a method of manufacturing the liquid lens array 100 according to an exemplary embodiment of the present invention will be described. First, in a state where the substrate 101 based on a polymer, such as

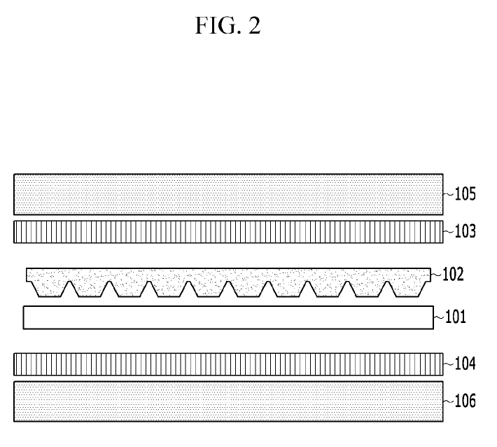

PMMA, or based on acryl is heated to 100° C. or more in a procedure, such as a hot embossing method in a general semiconductor process, as illustrated in FIG. 2, a mold 102, in which a shape of the plurality of chambers 130 is formed in a lower portion thereof and which is formed of a metal, is disposed on the substrate 101, and in a state where compression assisting plates 103 and 104 and compressing plates 105 and 106 are disposed in an upper portion of the mold 102 and a lower portion of the substrate 101, respectively, a predetermined pressure is applied to the mold 102 by using the compressing plates 105 and 106 for 10 minutes or longer to form a plurality of chambers 130 on the substrate 101 according to the shape of the plurality of chambers 130 formed in the mold 102. Here, for example, the mold is an electroplated metal material, and the metal material is obtained by molding a silicon etched shape.

Then, a dry film photo resist (PR) that is a negative photosensitive material is laminated on an exterior surface of the substrate 101 in a procedure, such as a lithography processing process, and then exposure is performed for 45 seconds by using a mask formed with an open surface so as to allow UV light to pass through according to a desired electrode pattern, that is, as illustrated in FIG. 1, a mask formed with an open surface so that the first electrode 140 and the second electrode 150 may be formed on both wall surfaces of the chamber 130. In this case, as illustrated in FIG. 1, the mask is formed with the open surface so that the first electrode 140 and the second electrode 150 may be formed on both wall surfaces of the chamber 130. That is, the electrode pattern has a pattern, by which the electrodes 140 and 150 of both wall surfaces of each chamber 130 are separated from each other.

As described above, after the exposure process is completed, a post exposure baking (PEB) process that is a heat treatment operation after the exposure is performed at 90° C. for one minute. After the performance of the process, when the product is dipped in a developer (Na₂CO₃) and is inserted into an ultra sonicator, and a vibration is applied to the ultra sonicator for one minute, only the PR in the exposed portion is left and the remaining part is melted and disappears.

Next, a Cr/Au electrode is deposited on the substrate 101 by using an evaporator. As an example of the deposition, Cr may be deposited in 10 nm, and then Au may be sequentially deposited on Cr in 15 nm.

Then, when the substrate 101 is dipped in a remover (NaOH) and is inserted into the ultra sonicator, and then a vibration is applied to the ultra sonicator for three minutes, the remaining PR is melted and disappears, and the Cr/Au layer, which is deposited on the PR, is separated, and only the Cr/Au layer, which is deposited on a portion having no PR, is left. In this case, the Cr/Au electrode has a pattern corresponding to the initial PR pattern.

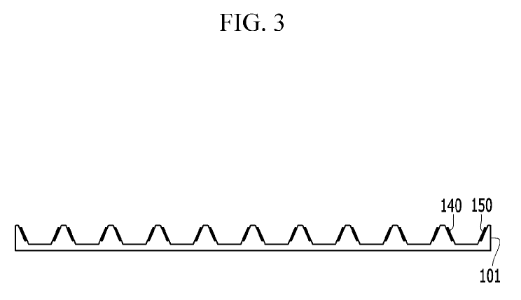

As described above, the substrate 101 after the two electrodes, that is, the first electrode 140 and the second electrode 150, are formed in each of the plurality of chambers 130, is illustrated in FIG. 3.

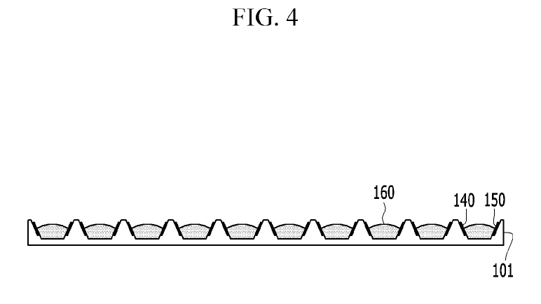

Then, when two kinds of liquids, that is, the hydrophobic liquid 160 and the electrolyte liquid 170, are injected into the substrate 101, in which the two electrodes 140 and 150 are completely separated, and the upper substrate 120 that is the transparent glass substrate covers the substrate 101 and seals the substrate 101, the liquid lens array 100 illustrated in FIG. 1 is completed. FIG. 4 is a diagram illustrating a state of the substrate 101 after the hydrophobic liquid is injected into the chamber 130 of the substrate 101, in which the two electrodes 140 and 150 are completely separated.

Here, there are several methods of injecting the hydrophobic liquid 160 and the electrolyte liquid 170 into the plurality of chambers 130 of the substrate 101. For example, in the exemplary embodiment of the present invention, when the substrate 101 is put into a water tank filled with the electrolyte liquid 170, that is, water, the plurality of chambers 130 formed on the substrate 101 is filled with water, and in this state, the hydrophobic liquid 160, that is, oil, inside each chamber 130 is dosed by using a micro syringe. Then, the upper portion of the substrate 101 is sealed with the glass substrate, that is, the upper substrate 120 within the water tank, so that the liquid lens array 100 according to the exemplary embodiment of the present invention is formed.

As a matter of course, the fact that an additional operation needs to be performed on the liquid lens array 100 so that a direct current or an alternating current may be applied to the two electrodes, that is, the first electrode 140 and the second electrode 150, respectively, is already well known, so that a description thereof will be omitted.

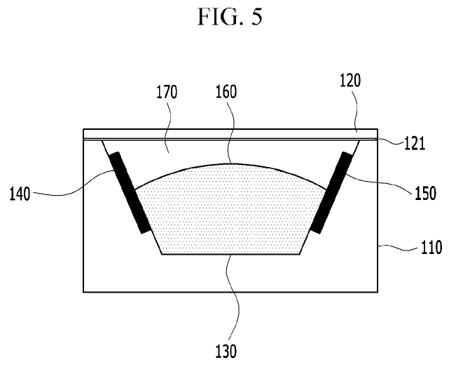

A lateral cross-sectional view of the basic unit liquid lens corresponding to one chamber in the liquid lens array 100 manufactured by the aforementioned method is illustrated in FIG. 5.

All of the plurality of chambers 130 formed in the liquid lens array 100 according to the exemplary embodiment of the present invention are formed in the same structure, so that the operations thereof are the same, so that herein, an operation of the liquid lens array 100 according to the exemplary embodiment of the present invention using one basic unit liquid lens illustrated in FIG. 5 will be described.

As illustrated in FIG. 5, when the same voltage is applied to the two electrodes 140 and 150 formed in the basic unit liquid lens by using two direct-current or alternating-current supplies, it is possible to implement convex lenses and concave lenses having various diopters. The basic unit liquid lens illustrated in FIG. 5 represents a convex lens formed by a change in a curvature between the hydrophobic liquid 160 and the electrolyte liquid 170 by applying the same voltage to the two electrodes 140 and 150 as one example of the lenses.

As described above, in the liquid lens array 100 according to the exemplary embodiment of the present invention, it is possible to transform a shape of the liquid to a desired form by controlling a voltage applied to the two electrodes 140 and 150 formed on both wall surfaces of the chamber 130. In the meantime, when the same voltage is not applied to the two electrodes 140 and 150 formed in the basic unit liquid lens and different voltages are applied to the electrodes 140 and 150, the lens has a form, in which the liquid is inclined according to a voltage difference.

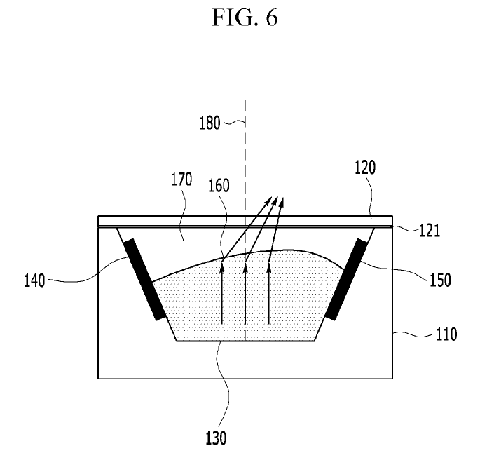

For example, when it is assumed that a voltage applied between the electrode 140 and the electrode 121 is V1, and a voltage applied between the electrode 150 and the electrode 121 is V2, when the voltage V1 is larger than the voltage V2, as illustrated in FIG. 6, an interface between the hydrophobic liquid 160 and the electrolyte liquid 170 is inclined from the electrode 150 side to the electrode 140 side, and as a result, the lens having a form, in which an optical axis is inclined to a left side of an existing optical axis 180 is implemented, and thus, light incident from a lower end of the liquid lens array 100 is refracted to a right side of the existing optical axis and is discharged through an upper end of the liquid lens array 100.

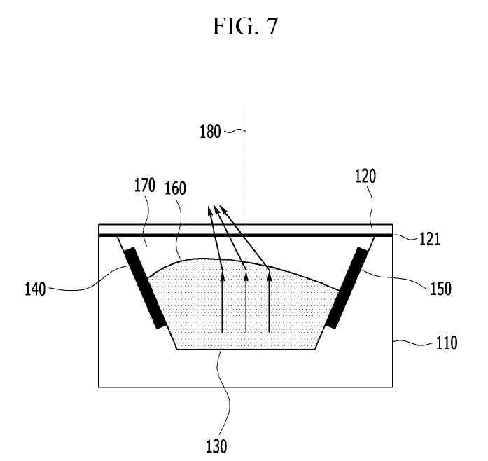

As another example, when the voltage V2 is larger than the first voltage V1, as illustrated in FIG. 7, an interface between the hydrophobic liquid 160 and the electrolyte liquid 170 is inclined from the electrode 140 side to the electrode 150 side, and as a result, the lens having a form, in which an optical axis is inclined to a right side of an existing optical axis 180 is implemented, and thus, light incident from a lower end of the liquid lens array 100 is refracted to a left side of the existing optical axis and is discharged through an upper end of the liquid lens array 100.

As described above, according to the exemplary embodiment of the present invention, it is possible to change an optical axis of the lens formed by the hydrophobic liquid 160 and the electrolyte liquid 170 filled inside the chamber 130 by separately forming the two electrodes 140 and 150 on both side surfaces of each of the plurality of chambers 130 and differentiating the voltages applied to the two electrodes 140 and 150. Particularly, it is possible to implement the lens having the form, in which the optical axis is inclined by 3° or more to the left side or the right side by adjusting a difference in the voltage applied to the two electrodes 140 and 150.

As described above, the viewpoint of the liquid lens array 100 according to the exemplary embodiment of the present invention is positioned at a position moving to the side from an existing viewpoint when there is no difference in the voltage applied to the two electrodes 140 and 150 of each chamber 130. When the voltage difference between both electrodes 140 and 150 is repeatedly adjusted at a high speed, for example, a driving speed of 60 Hz or more, by using the aforementioned phenomenon, it is possible to obtain an effect in increasing the number of viewpoints which is increased by a multiple of the number of existing viewpoints.

Contents of the implementation of a 3D display device based on a lenticular method by using a change in a shape of the liquid lens array 100 according to the exemplary embodiment of the present invention will be described.

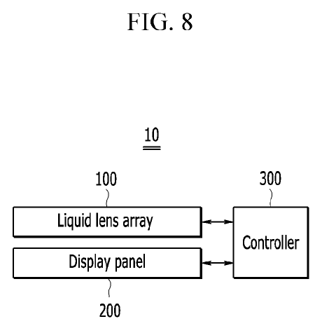

FIG. 8 is a schematic configuration diagram of a display device according to an exemplary embodiment of the present invention.

As illustrated in FIG. 8, a display device 10 according to an exemplary embodiment of the present invention includes a display panel 200, a liquid lens array 100, and a controller 300.

The display panel 200 is a display device, which includes unit pixels R, G, and B, and displays an image, and is a general display panel used for displaying an image in a liquid crystal display (LCD), a light emitting diode (LED) display, and an organic light emitting diode (OLED) display.

The liquid lens array 100 is the liquid lens array 100 described with reference to FIGS. 1 to 7, and provides various lens shape, in which an optical axis is inclined by transforming a shape between the hydrophobic liquid 160 and the electrolyte liquid 170 filled inside the chamber 130 by adjusting a voltage applied to the two separated electrodes 140 and 150 formed on left and right wall surfaces of an individual cell corresponding to each of the plurality of chambers 130.

The liquid lens array 100 and the display panel 200 may be bonded to each other, or may have a form of being bonded by using an adhesive only in border portions of the liquid lens array 100 and the display panel 200 so that a fine space is formed between the liquid lens array 100 and the display panel 200.

The controller 300 transforms a shape of the liquid lens array 100, that is, a shape between the hydrophobic liquid 160 and the electrolyte liquid 170, by applying a voltage to each of the electrode 140 and the electrode 150 of the liquid lens array 100 and adjusts the shape of the liquid lens array 100 to a lens shape, in which an optical axis is inclined. In this case, in order for the controller 300 to adjust the shape between the hydrophobic liquid 160 and the electrolyte liquid 170 to a shape, in which the optical axis is at a center of the lens, a shape, in which the optical axis is inclined to the left side, or a shape, in which the optical axis is inclined to the right side, a size of the voltage applied to each of the electrodes 140 and 150 may be different according to the liquid lens array 100, and the point that the corresponding voltage may be determined through an experiment or measurement statistics of the corresponding liquid lens array 100 will be easily understood by those skilled in the art.

Further, the controller 300 controls a voltage applied to the liquid lens array 100 so as to have an appropriate form of lens shape suitable to an image displayed in the display panel 200 through communication between the liquid lens array 100 and the display panel 200, and performs a control, under which the liquid lens array 100 and the display panel 200 may be synchronized by maintaining a high speed, for example, a driving speed of 60 Hz or more.

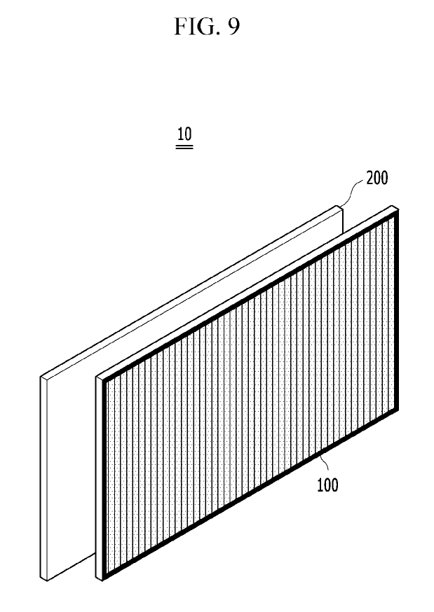

A perspective view of the aforementioned display device 10 is illustrated in FIG. 9. Referring to FIG. 9, it can be seen that in the liquid lens array 100, the plurality of chambers 130 is arranged in the horizontal and vertical directions on a 2D plane.

As described above, in the display device 10 according to the exemplary embodiment of the present invention, it is possible to simultaneously form a viewpoint group in a space by time-division driving the liquid lens array 100 based on the electrowetting method. Accordingly, it is possible to secure the two or more times of viewpoints without loss of resolution in the display device 10, so that it is possible to transmit more various and natural view information to an observer and implement a 3D image having a higher quality compared to that of a general multi-view method.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. A liquid lens array, comprising:
a first substrate including a plurality of chambers, and a first electrode and a second electrode, which are not connected with each other, and are formed on both side surfaces of each of the plurality of chambers, respectively; and
a second substrate configured to seal an upper portion of the first substrate including the plurality of chambers, and including a third electrode formed at a side facing the first substrate,
wherein a first liquid is filled in a lower portion of the chamber, and a second liquid, which is not mixed with the first liquid, is filled in an upper portion of the first liquid in the chamber.

2. The liquid lens array of claim 1, wherein:
an insulating layer is formed in an upper portion of each of the first electrode and the second electrode, and
a hydrophobic layer is formed on the insulating layer.

3. The liquid lens array of claim 1, wherein:
the first liquid is oil that is a hydrophobic liquid, and
the second liquid is water that is an electrolyte liquid.

4. The liquid lens array of claim 1, wherein:
when a first voltage applied between the first electrode and the third electrode is the same as a second voltage applied between the second electrode and the third electrode, a shape of an interface between the first liquid and the second liquid is a convex lens shape, in which an optical axis is positioned at a center of the lens.

5. The liquid lens array of claim 1, wherein:
when a first voltage applied between the first electrode and the third electrode is different from a second voltage applied between the second electrode and the third electrode, a shape of an interface between the first liquid and the second liquid is a convex lens shape, in which an optical axis is inclined to a left side or a right side from a center.

6. The liquid lens array of claim 5, wherein:
when the first voltage is larger than the second voltage, a shape of an interface between the first liquid and the second liquid is a convex lens shape, in which an optical axis is inclined to the first electrode side, and
when the second voltage is larger than the first voltage, a shape of an interface between the first liquid and the second liquid is a convex lens shape, in which an optical axis is inclined to the second electrode side.

7. A method of manufacturing a liquid lens array, the method comprising:
forming a plurality of chambers on a first substrate by compressing the first substrate with a mold, in which a plurality of chamber shapes is formed;
patterning the chambers on the first substrate by using a negative photoresist;
forming a first electrode and a second electrode on both side surfaces of the patterned first substrate, respectively;
injecting a first liquid to a lower portion of the plurality of chambers, and injecting a second liquid, which is not mixed with the first liquid, to an upper portion of the first liquid; and
sealing the upper portion of the first substrate including the plurality of chambers with a second substrate.

8. The method of claim 7, wherein:
the injecting of the first liquid to the lower portion of the plurality of chambers, and the injecting of the second liquid, which is not mixed with the first liquid, to the upper portion of the first liquid includes:
putting the first substrate into a water tank filled with the second liquid, and filling the plurality of chambers on the first substrate with the second liquid;
dosing the first liquid within the plurality of chambers by using a micro syringe and positioning the first liquid in a lower portion of the second liquid within the chamber; and
sealing the upper portion of the first substrate with the second substrate within the water tank.

9. The method of claim 7, wherein:
the first liquid is oil that is a hydrophobic liquid, and
the second liquid is water that is an electrolyte liquid.

10. A display device, comprising:
a display panel configured to display an image;
a liquid lens array, which is disposed at a side of the display panel, in which an image is displayed, which includes a first substrate including a plurality of chambers, and a first electrode and a second electrode formed at both side surfaces of each of the plurality of chambers, respectively, and not connected with each other, and a second substrate sealing an upper portion of the first substrate including the plurality of chambers and including a third electrode formed at a side facing the first substrate, in which a first liquid is filled in a lower portion of the chamber and a second liquid, which is not mixed with the first liquid, is filled in an upper portion of the first liquid in the chamber; and
a controller configured to control an optical axis of a lens formed by a shape between the first liquid and the second liquid to be inclined to left and right sides by applying a voltage to the liquid lens array.

11. The display device of claim 10, wherein:
the controller controls a voltage applied to the liquid lens array so as to have a lens shape suitable to an image displayed on the display panel through communication between the liquid lens array and the display panel.

12. The display device of claim 10, wherein:
the controller
controls an optical axis of a lens formed by an interface between the first liquid and the second liquid to be positioned at a center of the lens by applying a voltage so that a first voltage applied between the first electrode and the third electrode is the same as a second voltage applied between the second electrode and the third electrode.

13. The display device of claim 10, wherein:
the controller
controls an optical axis of a lens formed by an interface between the first liquid and the second liquid to be inclined to a left side or a right side from a center of the lens by applying a voltage so that a first voltage applied between the first electrode and the third electrode is different from a second voltage applied between the second electrode and the third electrode.
